(19) United States
(12) Patent Application Publication
(10) Pub. No.: US 2025/0390177 A1
(43) Pub. Date: Dec. 25, 2025

(54) GESTURE SENSING SYSTEM AND ELECTRONIC DEVICE

(71) Applicant: Samsung Display Co., LTD., Yongin-si (KR)

(72) Inventors: Satoshi UCHINO, Yokohama (JP); Kazuhiro MATSUMOTO, Yokohama (JP); Masahiko TAKIGUCHI, Yokohama (JP)

(21) Appl. No.: 19/195,136

(22) Filed: Apr. 30, 2025

(30) Foreign Application Priority Data
Jun. 20, 2024 (KR) 10-2024-0080622

(51) Int. Cl. G06F 3/01; G01S 7/41; G01S 13/58

(52) U.S. Cl. CPC G06F 3/017; G01S 7/415; G01S 13/581

(57) ABSTRACT

A gesture sensing system includes: a sensing unit, which senses a gesture of an object and generates and outputs input information including a plurality of sensing signals; a preprocessing unit, which detects a peak signal among the plurality of sensing signals and converts the input information into correction input information using information associated with the peak signal; and a classification unit, which is trained using training data and classifies the gesture based on the correction input information. The information associated with the peak signal includes information related to a position of the peak signal and an intensity of the peak signal, and the position of the peak signal and the intensity of the peak signal are uniformized to a uniform range and then provided to the classification unit.

This application claims priority to Korean Patent Application No. 10-2024-0080622, filed on Jun. 20, 2024, and all the benefits accruing therefrom under 35 U.S.C. § 119, the content of which in its entirety is herein incorporated by reference.

### BACKGROUND

Embodiments of the present disclosure described herein relate to a gesture sensing system and an electronic device, and more particularly, relate to a gesture sensing system capable of sensing gestures of an object and an electronic device.

Millimeter waves have a high-band frequency of 30 gigahertz (GHz) to 300 GHz. The millimeter waves have strong straight-line properties and are not affected by weather such as rain or fog, so they are also applied to automatic driving technologies such as collision avoidance in automobiles.

In addition, since an antenna that transmits and receives the millimeter waves may be miniaturized, the millimeter waves may also be used for monitoring traffic and crime prevention sensors for surveillance.

### SUMMARY

Embodiments of the present disclosure provide a gesture sensing system capable of sensing gestures of an object and an electronic device.

According to an embodiment of the present disclosure, a gesture sensing system includes: a sensing unit, which senses a gesture of an object and generates and outputs input information including a plurality of sensing signals; a preprocessing unit, which detects a peak signal among the plurality of sensing signals and converts the input information into correction input information using information associated with the peak signal; and a classification unit, which is trained using training data and classifies the gesture based on the correction input information. The information associated with the peak signal includes information related to a position of the peak signal and an intensity of the peak signal, and the position of the peak signal and the intensity of the peak signal are uniformized to a uniform range and then provided to the classification unit.

According to an embodiment, the preprocessing unit may include: a motion detection unit, which senses whether the gesture is sensed; a signal detection unit, which detects the peak signal among the plurality of sensing signals; a position correction unit, which corrects the position of the peak signal and outputs a correction position of the peak signal; and an intensity correction unit, which corrects the intensity of the peak signal and outputs a correction intensity of the peak signal.

According to an embodiment, the input information may further include a range signal including information associated with a distance between the sensing unit and the object, and a Doppler signal including information associated with a speed of the object. A position of each of the plurality of sensing signals may be a position on a range-Doppler map expressed by the range signal and the Doppler signal, the sensing unit may generate the input information for each frame, and the correction input information may include information associated with the correction position of the peak signal and the correction intensity of the peak signal with respect to given frames.

According to an embodiment, the motion detection unit may calculate a differential signal intensity by using a difference in signal intensity with respect to the range-Doppler map of each frame and a previous frame of the each frame among the given frames, may calculate an average value of the differential signal intensities of the given frames, and may determine whether the gesture is sensed using the average value.

According to an embodiment, the motion detection unit may calculate a differential signal intensity by using a difference in signal intensity with respect to the range-Doppler map of two adjacent frames, may calculate a normalized signal intensity by normalizing the differential signal intensity, and may determine whether the gesture is sensed using the normalized signal intensity.

According to an embodiment, the signal detection unit may select sensing signals having an intensity greater than a set threshold value among the plurality of sensing signals.

According to an embodiment, the signal detection unit may select a first signal, a second signal, a third signal, and a fourth signal from among selected sensing signals for each frame, and the first signal may be a sensing signal having a greatest intensity among the selected sensing signals, the second signal may be a sensing signal having a smallest difference from center positions of the selected sensing signals, the third signal may be a sensing signal having a smallest difference in position between a previous frame and a current frame among the selected sensing signals, and the fourth signal may be a sensing signal located at a position where a Doppler is minimum or maximum among the selected sensing signals.

According to an embodiment, the signal detection unit may detect a sensing signal at a position where the range is a smallest among the first to fourth sensing signals as the peak signal.

According to an embodiment, the position correction unit may determine whether a current frame is a first frame. The first frame may be a frame at which the motion detection unit determines that the gesture is initiated.

According to an embodiment, the position correction unit may calculate the position of the detected peak signal as an initiation position when the current frame is the first frame, and may calculate a difference between the position of the current frame and a position of a previous frame when the current frame is not the first frame.

According to an embodiment, the position correction unit may not correct the position of the current frame when the difference is within a reference distance, and may correct the position of the peak signal of the current frame when the difference exceeds the reference distance.

According to an embodiment, the intensity correction unit may correct the intensity of the peak signal using the training data, and the training data may include information on a correlation between a range of the peak signal and the intensity of the peak signal.

According to an embodiment, the training data may include information on recognizable gestures for a training target as one, or may include information on each gesture, of recognizable gestures, for a training target as an individual.

According to an embodiment, the intensity correction unit may compare the intensity of the peak signal for each gesture with the intensity of the peak signal during given frames, may select the gesture for which the intensity of the peak signal is closest to the intensity of the peak signal during the given frames among the gestures, and may correct the intensity of the peak signal based on the selected gesture.

According to an embodiment, the sensing unit may generate an intermediate signal using a transmission signal and a reception signal, may convert the intermediate signal into intermediate signal data through an analog-to-digital conversion, and may apply a Fourier transform to the intermediate signal data so as to be converted into the input information.

According to an embodiment, the sensing unit may apply the Fourier transform to the intermediate signal data to calculate a range signal, and may apply the Fourier transform to the range signal to calculate a Doppler signal.

According to an embodiment, the transmission signal and the reception signal may be millimeter waves.

According to an embodiment, the classification unit may include a convolution neural network and a long short-term memory, in a training process of the classification unit, the convolution neural network may receive the training data to be trained, and in a classification process of the classification unit, the long short-term memory may output a predicted gesture.

According to an embodiment of the present disclosure, an electronic device includes a sensing unit, which senses a gesture of an object and generates and outputs input information including a plurality of sensing signals, a preprocessing unit, which detects a peak signal among the plurality of sensing signals and converts the input information into correction input information using information associated with the peak signal, and a classification unit, which is trained using training data and classifies the gesture based on the correction input information. The information associated with the peak signal includes information related to a position of the peak signal and an intensity of the peak signal, and the position of the peak signal and the intensity of the peak signal are uniformized to a uniform range and then provided to the classification unit.

### BRIEF DESCRIPTION OF THE FIGURES

The above and other objects and features of the present disclosure will become apparent by describing in detail embodiments thereof with reference to the accompanying drawings.

FIG. 1 is a block diagram of a gesture sensing system, according to an embodiment of the present disclosure.

FIG. 2 is a block diagram of a sensing unit, according to an embodiment of the present disclosure.

FIG. 3A is a diagram illustrating a range and a Doppler as an example, according to an embodiment of the present disclosure.

FIG. 3B is a diagram illustrating a range-Doppler map as an example, according to an embodiment of the present disclosure.

FIG. 4 is a block diagram of a preprocessing unit, according to an embodiment of the present disclosure.

FIG. 5 is a flowchart illustrating an operation of a preprocessing unit, according to an embodiment of the present disclosure.

FIG. 6 is a graph illustrating values used in a motion detection process of a motion detection unit, according to an embodiment of the present disclosure.

FIG. 7 is a flowchart illustrating an operation of a signal detection unit, according to an embodiment of the present disclosure.

FIG. 8 is a diagram for describing an operation of a position correction unit, according to an embodiment of the present disclosure.

FIG. 9 is a graph illustrating a correlation between a peak distance and a peak intensity, according to an embodiment of the present disclosure.

FIG. 10 is a flowchart illustrating an operation of an intensity correction unit, according to an embodiment of the present disclosure.

FIG. 11A is a graph illustrating a correlation between a peak distance and a peak intensity for a gesture “A”, according to an embodiment of the present disclosure.

FIG. 11B is a graph illustrating a correlation between a peak distance and a peak intensity for a gesture “B”, according to an embodiment of the present disclosure.

FIG. 11C is a graph illustrating a correlation between a peak distance and a peak intensity for a gesture “C”, according to an embodiment of the present disclosure.

FIG. 11D is a graph illustrating a correlation between a peak distance and a peak intensity for a gesture “D”, according to an embodiment of the present disclosure.

FIG. 12A and FIG. 12B are block diagrams of a classification unit, according to an embodiment of the present disclosure.

FIG. 13 is a diagram illustrating types of gestures, according to an embodiment of the present disclosure.

FIG. 14A is a graph illustrating a correlation between a peak distance and a peak intensity, according to a comparative example.

FIG. 14B is a graph illustrating a correlation between a peak distance and a peak intensity, according to an embodiment of the present disclosure.

### DETAILED DESCRIPTION

In the specification, when one component (or area, layer, part, or the like) is referred to as being “on”, “connected to”, or “coupled to” another component, it should be understood that the former may be directly on, connected to, or coupled to the latter, and also may be on, connected to, or coupled to the latter via a third intervening component.

Like reference numerals refer to like components. Also, in drawings, the thickness, ratio, and dimension of components are exaggerated for effectiveness of description of technical contents. The term “and/or” includes one or more combinations of the associated listed items.

The terms “first”, “second”, etc. are used to describe various components, but the components are not limited by the terms. The terms are used only to differentiate one component from another component. For example, a first component may be named as a second component, and vice versa, without departing from the spirit or scope of the present disclosure. A singular form, unless otherwise stated, includes a plural form.

Also, the terms “under”, “beneath”, “on”, “above” are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless defined otherwise, all terms (including technical and scientific terms) used herein have the same meaning as commonly understood by one of ordinary skill in the art to which this disclosure belongs. In addition, terms such as terms defined in commonly used dictionaries should be interpreted as having a meaning consistent with the meaning in the context of the related technology, and should not be interpreted as an ideal or excessively formal meaning unless explicitly defined in the present disclosure.

Hereinafter, embodiments of the present disclosure will be described with reference to accompanying drawings.

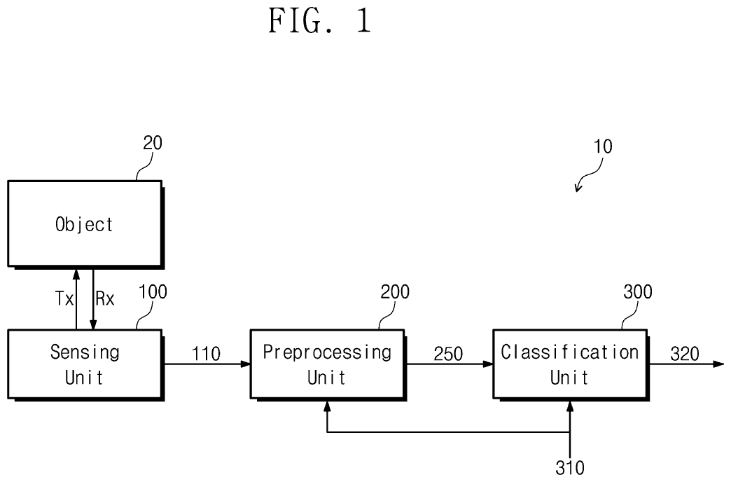

FIG. 1 is a block diagram of a gesture sensing system, according to an embodiment of the present disclosure.

Referring to FIG. 1, a gesture sensing system 10 may include a sensing unit 100, a preprocessing unit 200, and a classification unit 300.

The gesture sensing system 10 may sense an object 20 using a phase difference between a transmission signal TX and a reception signal RX caused by a physical distance between the gesture sensing system 10 and the object 20.

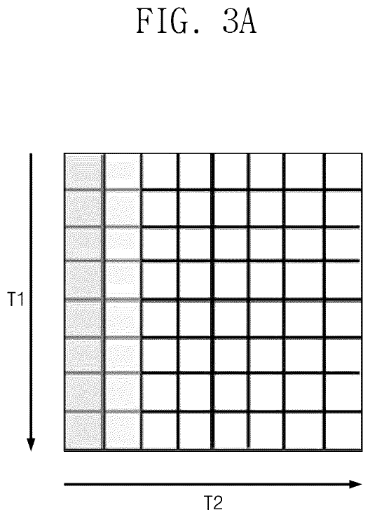

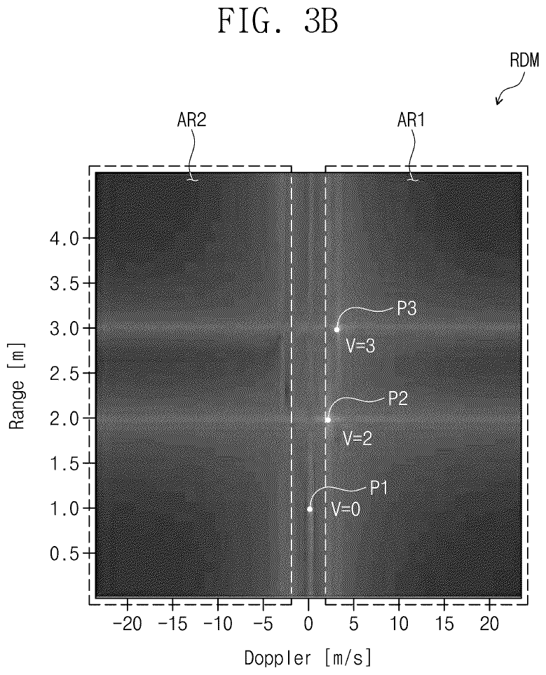

The sensing unit 100 may transmit the transmission signal TX to the object 20 and may receive the reception signal RX that is a reflection of the transmission signal TX from the object 20. The sensing unit 100 may generate and output the input information 110 for each frame based on the transmission signal TX and the reception signal RX. The input information 110 may include a plurality of digitalized sensing signals, a signal regarding a distance between the sensing unit 100 and the object 20, and a signal regarding the relative speed of the object 20. The sensing signals of the corresponding frame may be expressed on a range-Doppler map RDM (refer to FIG. 3B) through analysis of a range signal and a Doppler signal. Hereinafter, information regarding the distance between the sensing unit 100 and the object 20 is referred to as a range, and information regarding the relative speed of the object 20 is referred to as a Doppler.

The preprocessing unit 200 may receive the input information 110 from the sensing unit 100, may convert the input information 110 into correction input information 250, and may output the correction input information 250. Since the various pieces of information included in the correction input information 250 are pieces of information that are corrected within a specific range from the various pieces of information included in the input information 110, the correction input information 250 may include information that is more uniform than the input information 110. Information about some (or peak signals) of the sensing signals included in the input information 110 may include information about a position of a peak signal and an intensity of the peak signal. The correction input information 250 may include a correction position of the peak signal, which corrects the position of the peak signal within a specific range among the information about the peak signal. The preprocessing unit 200 may generate the correction intensity of the peak signal by correcting the intensity of the peak signal within a specific range based on the correction position of the peak signal. The preprocessing unit 200 may use training data 310 in a process of correcting the intensity of the peak signal.

The classification unit 300 receives the correction input information 250 from the preprocessing unit 200 and receives the training data 310 from a user. The classification unit 300 may perform training based on the training data 310 in the training process. The classification unit 300 may receive the correction input information 250 from the preprocessing unit 200 in the classification process, and may represent the classification of gestures for a training target by type as gesture probabilities. The classification unit 300 may select and output a gesture with the highest probability as a predicted gesture 320.

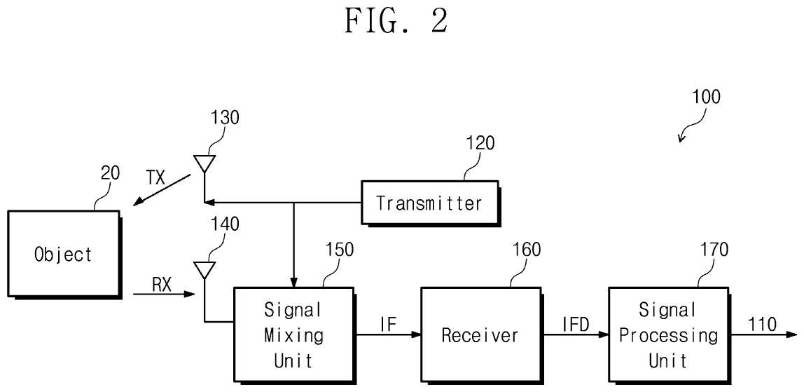

FIG. 2 is a block diagram of a sensing unit, according to an embodiment of the present disclosure.

Referring to FIG. 2, the sensing unit 100 may include a transmitter 120, a transmitting antenna 130, a receiving antenna 140, a signal mixing unit 150, a receiver 160, and a signal processing unit 170.

The transmitter 120 may output the millimeter wave transmission signal TX to the transmitting antenna 130 and the signal mixing unit 150. The millimeter wave transmission signal TX output from the transmitting antenna 130 may be reflected by the object 20 and transferred to the receiving antenna 140 as the millimeter wave reception signal RX. The signal mixing unit 150 may combine the transmission signal TX received from the transmitter 120 and the reception signal RX received from the receiving antenna 140 to generate and output an intermediate signal IF. The transmission signal TX, the reception signal RX, and the intermediate signal IF may have different frequencies. As an example of the present disclosure, the transmission signal TX is a frequency modulation signal whose frequency increases linearly from 77 GHz to 81 GHz, and the transmitter 120 may repeatedly output the transmission signal TX in the form of pulses at uniform time intervals.

The intermediate signal IF may include information about a phase difference between the transmission signal TX and the reception signal RX caused by a physical distance difference between the transmitting antenna 130 and the receiving antenna 140, the intensity of the reception signal RX, etc.

The receiver 160 may receive the intermediate signal IF from the signal mixing unit 150, and may perform filtering and/or an analog-to-digital conversion operation on the intermediate signal IF to generate and output intermediate signal data IFD. For example, the intermediate signal IF may be an analog signal, and the intermediate signal data IFD may be a digital signal.

The signal processing unit 170 receives the intermediate signal data IFD from the receiver 160, converts the intermediate signal data IFD to generate the input information 110, and outputs the input information 110 for each frame. The input information 110 may include a plurality of sensing signals, range signals, and Doppler signals.

FIG. 3A is a diagram illustrating a range and a Doppler as an example, according to an embodiment of the present disclosure. FIG. 3B is a diagram illustrating a range-Doppler map as an example, according to an embodiment of the present disclosure.

Referring to FIGS. 3A and 3B, the signal processing unit 170 (refer to FIG. 2) may include a range converter and a Doppler converter. The range converter may perform a fast Fourier transform operation on the intermediate signal data IFD to obtain a range signal.

The range converter may perform a fast Fourier transform operation on the intermediate signal data IFD in a first period T1 to generate the range signal. The first period T1 may mean a period for sampling one reception signal RX. The range signal output from the range converter may be a signal indicating a distance between the sensing unit 100 (refer to FIG. 1) and the object 20 (refer to FIG. 1). The range converter may apply a fast Fourier transform once to the intermediate signal data IFD to generate the range signal.

The Doppler converter may generate a Doppler signal by performing a fast Fourier transform operation on the range signal acquired through the range converter in a second period T2. The second period T2 may mean a period of the reception signal RX. The Doppler signal may be a signal indicating a relative speed to the object 20 (refer to FIG. 1). The Doppler converter may generate a Doppler signal by applying a fast Fourier transform twice to the intermediate signal data IFD.

The range signal and the Doppler signal generated by the range converter and the Doppler converter, respectively, may be expressed in the form of a range-Doppler map RDM as illustrated in FIG. 3B. In the range-Doppler map RDM, a vertical axis may represent a range value calculated by analyzing the range signal, and a horizontal axis may represent a Doppler value calculated by analyzing the Doppler signal. The range value may be calculated in units of “m”, which is a unit of a length not limited to a meter, and the Doppler value may be calculated in units of m/s. The range-Doppler map RDM may be generated for each frame. The signal processing unit 170 (refer to FIG. 2) may further include a mapper that maps the sensing signal to the range-Doppler map RDM. A sensing signal corresponding to each position of the range-Doppler map RDM may be mapped. An x-position value of each position represents the size of the Doppler, and a y-position value represents the size of the range. In FIG. 3B, a relatively bright part may represent that the intensity of the sensing signal is relatively strong.

In FIG. 3B, a first sensing signal located at a first position P1, a second sensing signal located at a second position P2, and a third sensing signal located at a third position P3 are illustrated as an example. The first position P1 is a position where the Doppler is 0 m/s and the range is 1 m, the second position P2 is a position where the Doppler is 2 m/s and the range is 2 m, and the third position P3 is a position where the Doppler is 3 m/s and the range is 3 m. The position of the sensing signal may be defined as the position by a range and Doppler pair in the range-Doppler map RDM. The position of the sensing signal may indicate information about the range and the Doppler of the object 20 (refer to FIG. 1). In detail, the first sensing signal located at the first position P1 may indicate the presence of the object 20 (refer to FIG. 1) moving at a speed (V) of 0 m/s at a point 1 m away from the sensing unit 100 (refer to FIG. 1).

The signal processing unit 170 (refer to FIG. 2) may process the sensing signals located in a first area AR1 and a second area AR2 in the range-Doppler map RDM. In detail, when the object 20 exists at a point where the Doppler is 0 m/s and a predetermined section adjacent to 0 m/s, it is considered that the object 20 is not moving, and the sensing signals located in this section may be ignored without performing signal processing.

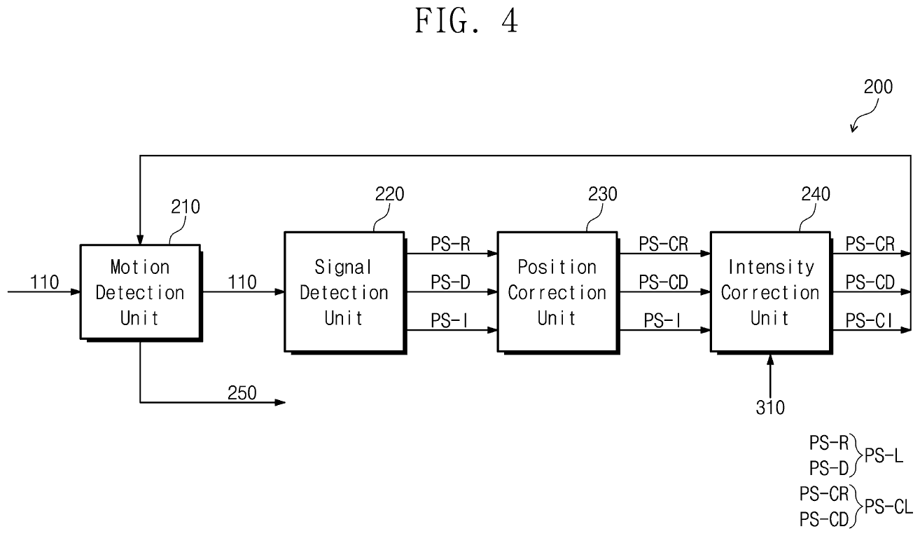

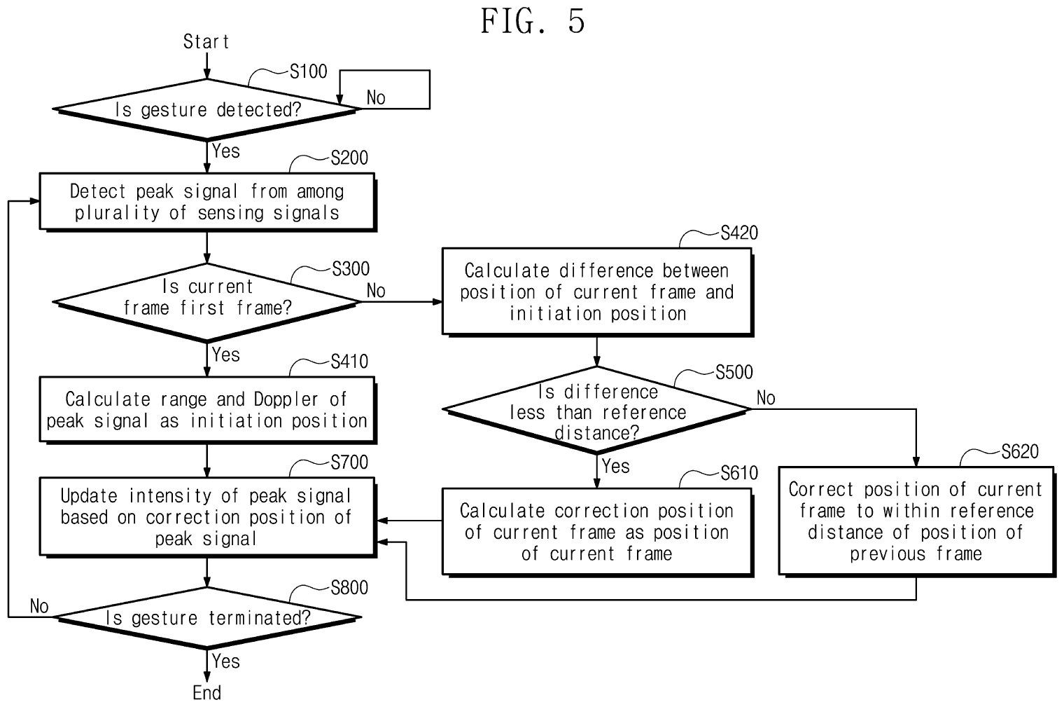

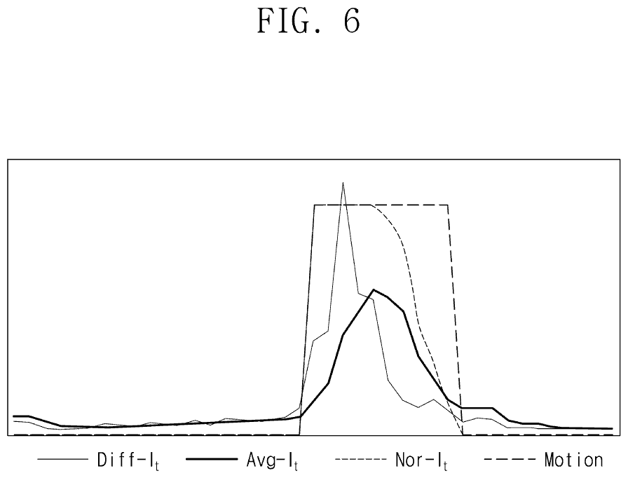

FIG. 4 is a block diagram of a preprocessing unit, according to an embodiment of the present disclosure. FIG. 5 is a flowchart illustrating an operation of a preprocessing unit, according to an embodiment of the present disclosure. FIG. 6 is a graph illustrating values used in a motion detection process of a motion detection unit, according to an embodiment of the present disclosure.

Referring to FIGS. 4, 5, and 6, the preprocessing unit 200 may include a motion detection unit 210, a signal detection unit 220, a position correction unit 230, and an intensity correction unit 240. The motion detection unit 210 receives the input information 110 from the sensing unit 100 (or the signal processing unit 170). The motion detection unit 210 may determine whether a gesture of the object 20 (refer to FIG. 1) is detected based on the input information 110. In an embodiment of the present disclosure, the determination of whether a gesture is detected may be a determination of whether a gesture is initiated or terminated. When it is determined that a gesture is initiated, the input information 110 may be output, and when the gesture is not initiated, the input information 110 may not be output (operation S100). When it is determined that the gesture is terminated, the motion detection unit 210 may provide the correction input information 250 to the classification unit 300 (refer to FIG. 1), and when the gesture is not terminated, the input information 110 may be output again (operation S800).

The motion detection unit 210 may calculate a difference between a signal intensity of the range-Doppler map RDM in a current frame (hereinafter referred to as a “current signal intensity”) and a signal intensity of the range-Doppler map RDM in a previous frame (hereinafter referred to as a “previous signal intensity”). The motion detection unit 210 may calculate a differential signal intensity Diff-Iₜ of two adjacent frames based on the difference between the current signal intensity and the previous signal intensity. The differential signal intensity Diff-Iₜ may be calculated from each of a plurality of frames. Here, the differential signal intensity Diff-Iₜ of each of a plurality of frames means a difference between a signal intensity of the range-Doppler map RDM in each frame and a signal intensity of the range-Doppler map RDM in a previous frame of the each frame. In an embodiment of the present disclosure, the signal intensity of the range-Doppler map RDM in the corresponding frame may represent an average of the intensities of the sensing signals expressed in the corresponding range-Doppler map RDM.

The motion detection unit 210 may calculate an average value Avg-Iₜ for the differential signal intensities Diff-Iₜ calculated for the number of preset frames. For example, the average value Avg-Iₜ may be an average value for the differential signal intensities Diff-Iₜ of five frames. The motion detection unit 210 may determine that a gesture is initiated when the average value Avg-Iₜ is greater than a preset reference value, and may determine that a moving is terminated when the average value Avg-Iₜ is less than or equal to the reference value. In an embodiment of the present disclosure, the motion detection unit 210 may also determine whether a gesture is detected using a normalized signal intensity Nor-Iₜ. The normalized signal intensity Nor-Iₜ is a value obtained by normalizing the differential signal intensities Diff-Iₜ based on the maximum and minimum values of the differential signal intensities Diff-Iₜ.

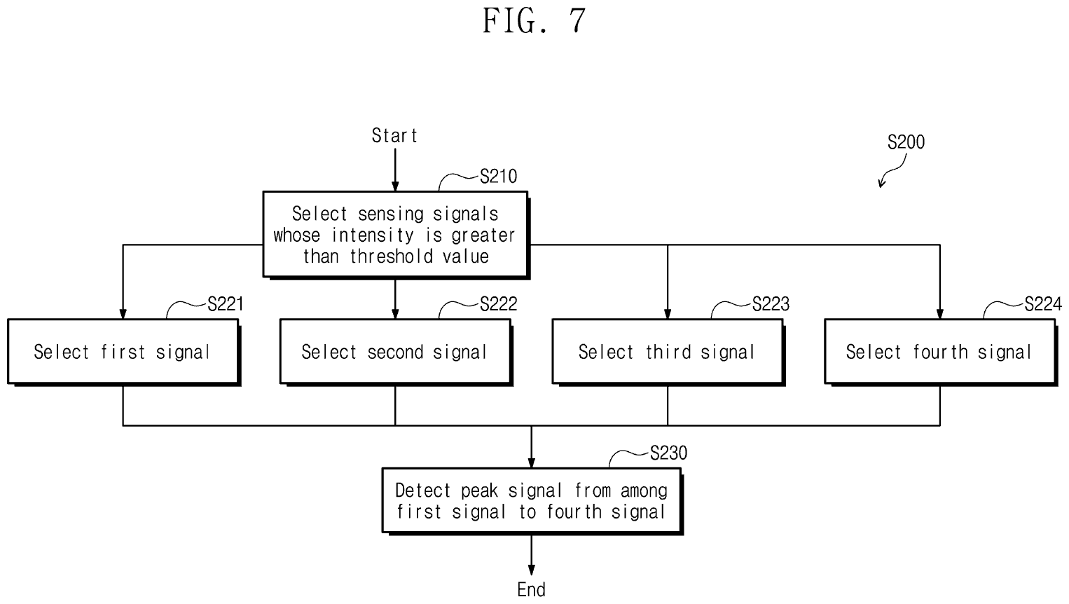

FIG. 7 is a flowchart illustrating an operation of a signal detection unit, according to an embodiment of the present disclosure.

Referring to FIGS. 4, 5, and 7, the signal detection unit 220 may receive the input information 110 from the motion detection unit 210 and may detect a peak signal among a plurality of sensing signals included in the input information 110 (operation S200). The signal detection unit 220 may output information about the peak signal for each frame. Hereinafter, the peak signal detected in a first frame is referred to as a first peak signal, and the peak signal detected in a second frame is referred to as a second peak signal. In this case, the first frame may be a frame at which the motion detection unit 210 determines that a gesture is initiated, and the second frame may be a frame that appears subsequent to the first frame.

The information about the peak signal includes a peak range PS-R and a peak Doppler PS-D that define a position of the peak signal PS-L located on the range-Doppler map RDM (refer to FIG. 3B. Information about the peak signal may further include an intensity PS-I of the peak signal.

The signal detection unit 220 may select sensing signals (hereinafter referred to as selected sensing signals) whose intensity is greater than a preset threshold value among the plurality of sensing signals included in the input information 110 (operation S210).

For each frame, first, second, third, and fourth signals may be selected again among the selected sensing signals. The first signal may be the sensing signal with the greatest intensity among the selected sensing signals (operation S221). The second signal may be the sensing signal with the minimum distance from a center position among the selected sensing signals (operation S222). The third signal may be the sensing signal with the minimum distance between a position in a previous frame and a position in a current frame among the sensing signals that appear in both the previous frame and the current frame among the selected sensing signals (operation S223). The fourth signal may be the sensing signal located at a position where the Doppler is minimum or maximum among the selected sensing signals (operation S224). In this case, the center position of the selected sensing signals may be calculated by multiplying each position of the selected sensing signals by its intensity to generate weighted positions, and then by obtaining the average value of the weighted positions as the center position. A signal at a position with the smallest range among the first to fourth signals may be detected as a peak signal of the corresponding frame (operation S230).

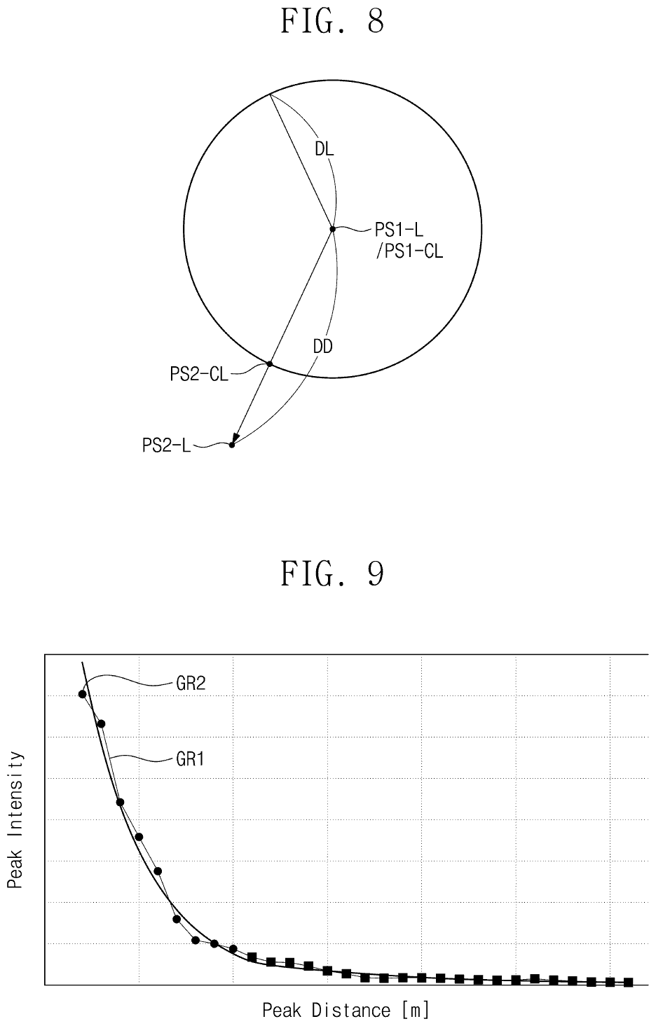

FIG. 8 is a diagram for describing an operation of a position correction unit, according to an embodiment of the present disclosure.

Referring to FIGS. 4, 5, and 8, the position correction unit 230 may receive information about the peak signal detected from the signal detection unit 220, may correct the position of the peak signal PS-L among the information about the peak signal, and may generate and output correction position PS-CL of the peak signal. The correction position PS-CL of the peak signal may be expressed as a correction peak range PS-CR and a correction peak Doppler PS-CD. The correction peak range PS-CR may be a value for which the peak range PS-R is corrected, and the correction peak Doppler PS-CD may be a value for which the peak Doppler PS-D is corrected. The position correction unit 230 may receive the intensity PS-I of the peak signal among the information about the peak signal, and may output the intensity PS-I of the peak signal as it is without correction.

The position correction unit 230 may determine whether the current frame is the first frame (operation S300). When the current frame is the first frame, the peak signal detected from the signal detection unit 220 is the first peak signal detected in the first frame, and a correction position PS1-CL (hereinafter referred to as an initiation position) of the first peak signal may be the same as a position PS1-L of the first peak signal (operation S410). The correction position PS1-CL of the first peak signal may be used as the initiation position to standardize the initiation positions of all gestures corresponding to the training range. When the current frame is not the first frame, the detected peak signal may be a peak signal other than the first peak signal. When the current frame is not the first frame, a difference between the position (which may be referred to as the position of the current frame) of the peak signal detected in the current frame and the position (which may be referred to as the position of the previous frame) of the peak signal detected in the previous frame may be calculated (operation S420). For example, the peak signal detected in a second frame may be a second peak signal. When the current frame is the second frame, a difference DD between a position PS2-L of the second peak signal detected in the second frame and the correction position PS1-CL of the first peak signal detected in the first frame may be calculated.

The calculated difference DD may be compared with a preset reference distance DL (operation S500). When the difference DD is less than or equal to the reference distance DL, the correction position of the current frame (e.g., a correction position PS2-CL of the second peak signal) may be the same as the position of the current frame (e.g., the position PS2-L of the second peak signal) (operation S610). When the difference DD is greater than the reference distance DL, the position of the peak signal of the current frame (the position PS2-L of the second peak signal) may be corrected such that the position of the peak signal of the current frame (the position PS2-L of the second peak signal) is within the reference distance DL from the position of the peak signal of the previous frame (the correction position PS1-CL of the first peak signal) (operation S620).

The intensity correction unit 240 may receive the correction position PS-CL of the peak signal and the training data 310, and may correct the intensity PS-I of the peak signal using the correction position PS-CL of the peak signal and the training data 310 (operation S700). The training data 310 according to an embodiment of the present disclosure may include information on the peak signals of all gestures with respect to a training range.

The intensity correction unit 240 may output the corrected information on the peak signal of the corresponding frame to the motion detection unit 210. The corrected information about the peak signal may include the correction peak range PS-CR and the correction peak Doppler PS-CD that define the correction position PS-CL of the peak signal, and may include a correction intensity PS-CI of the peak signal. The motion detection unit 210 may accumulate the corrected information about the peak signal of each frame, and when it is determined that the gesture is terminated, the motion detection unit 210 may output the corrected information about the peak signal from the first frame to the corresponding frame as the correction input information 250.

FIG. 9 is a graph illustrating a correlation between a peak distance and a peak intensity, according to an embodiment of the present disclosure. In FIG. 9, a first graph GR1 is a graph illustrating an actual peak intensity value according to the peak distance, and a second graph GR2 is a graph that approximates the first graph GR1 through a model such as regression analysis. The second graph GR2 illustrates a function of the peak distance with respect to the peak intensity.

Referring to FIGS. 4, 5, and 9, the training data 310 may include a correlation distribution between the peak distance and the peak intensity. A horizontal axis of the graph in FIG. 9 represents the peak distance, and a vertical axis represents the average value of the peak intensity for all gestures corresponding to the training range. In detail, the peak distance may mean the peak range with respect to the training data 310, and the peak intensity may represent the intensity of the peak signal with respect to the training data 310. However, the present disclosure is not limited thereto, and the training data 310 may include a distribution of correlations between the peak Doppler and the intensity of the peak signal with respect to the training data 310, and a distribution of correlations between the position of the peak signal and the intensity of the peak signal with respect to the training data 310 in another embodiment. The intensity PS-I of the peak signal with respect to the input information 110 may be corrected to the correction intensity PS-CI of the peak signal through the second graph GR2 using the correction peak range PS-CR as a factor.

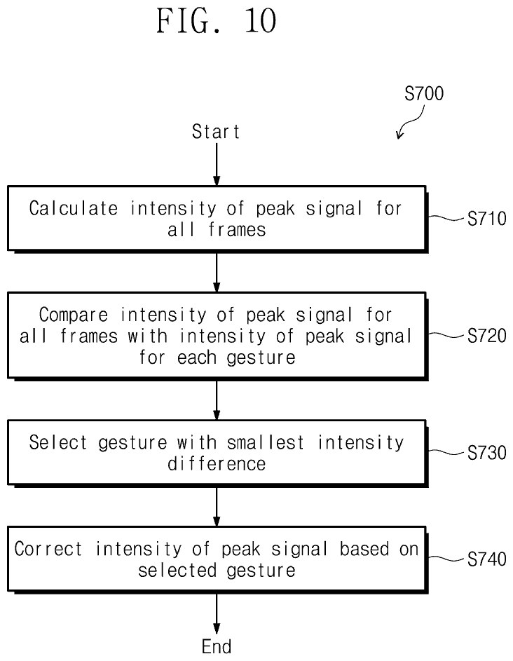

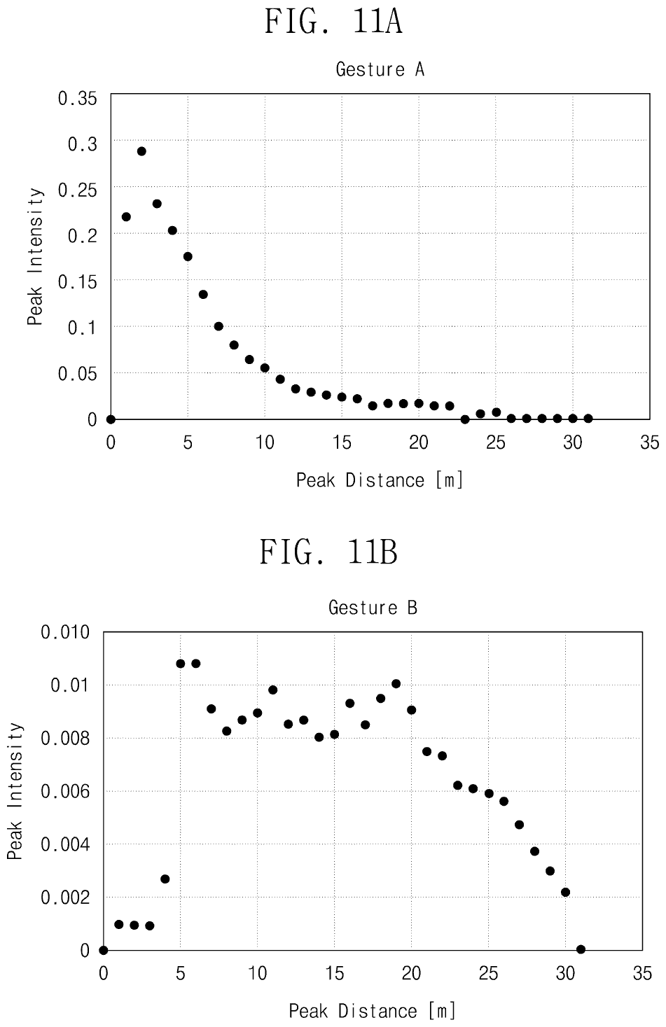

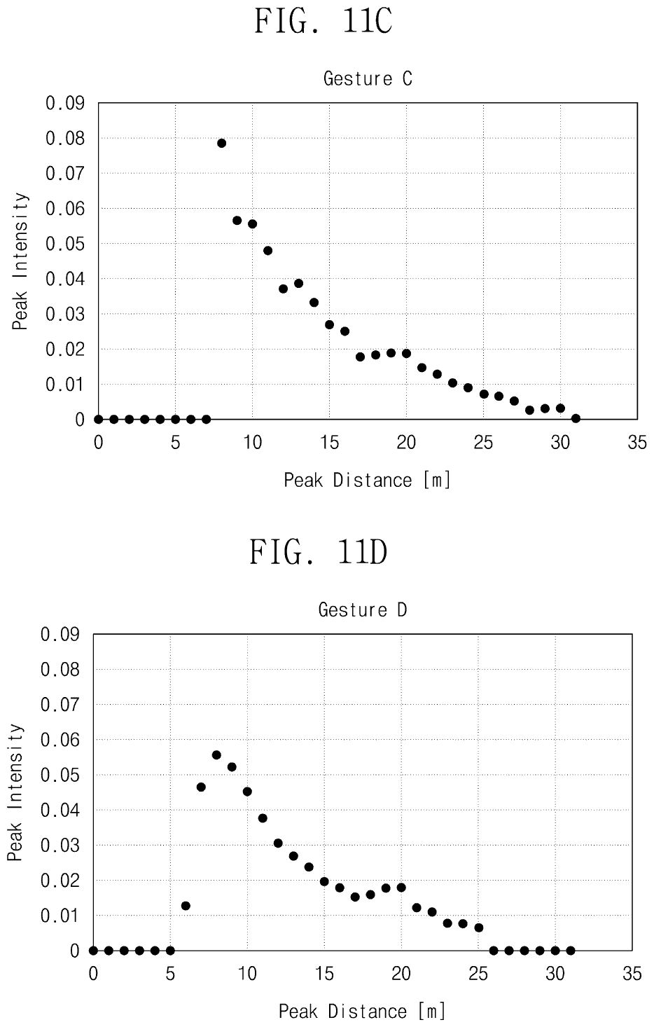

FIG. 10 is a flowchart illustrating an operation of an intensity correction unit, according to an embodiment of the present disclosure. FIG. 11A is a graph illustrating a correlation between a peak distance and a peak intensity for a gesture “A”, according to an embodiment of the present disclosure. FIG. 11B is a graph illustrating a correlation between a peak distance and a peak intensity for a gesture “B”, according to an embodiment of the present disclosure. FIG. 11C is a graph illustrating a correlation between a peak distance and a peak intensity for a gesture “C”, according to an embodiment of the present disclosure. FIG. 11D is a graph illustrating a correlation between a peak distance and a peak intensity for a gesture “D”, according to an embodiment of the present disclosure.

Referring to FIGS. 4, 10, and 11A to 11D, the training data 310 according to an embodiment of the present disclosure may include a distribution of correlations between peak distances and peak intensities with respect to each gesture.

The intensity correction unit 240 may calculate the intensity of the peak signal for all frames during a certain period (operation S710). In an embodiment of the present disclosure, an average intensity of the peak signal for the all frames, an accumulated intensity of the peak signal for the all frames, or other values that may represent values related to the intensity of the peak signal may be calculated and used as the intensity of the peak signal for the all frames. The calculated intensity of the peak signal for the all frames is compared with the intensity of the peak signal for each gesture (e.g., gestures A to D) (S720), and one gesture that has intensity closest to the calculated intensity of the peak signal for the all frames, among the intensities of the peak signals for the gestures A to D, may be selected (S730). The intensity PS-I of the peak signal may be corrected to the correction intensity PS-CI of the peak signal that approximates the peak intensity of the selected gesture by taking the correction peak range PS-CR as a factor.

Referring to FIGS. 4 and 5 again, after the intensity PS-I of the peak signal is corrected through the intensity correction unit 240, the motion detection unit 210 may determine whether the gesture is terminated (operation S800). When the gesture is terminated, information on the correction peak range PS-CR, the correction peak Doppler PS-CD, and the correction intensity PS-CI of the peak signal for N peak signals obtained during N (where “N” is a natural number greater than or equal to “1”) frames may be provided to the classification unit 300 (refer to FIG. 1) as the correction input information 250. When the gesture is not terminated, the process of detecting the peak signal in the range-Doppler map RDM for an N+1 frame (operation S200) may be performed again.

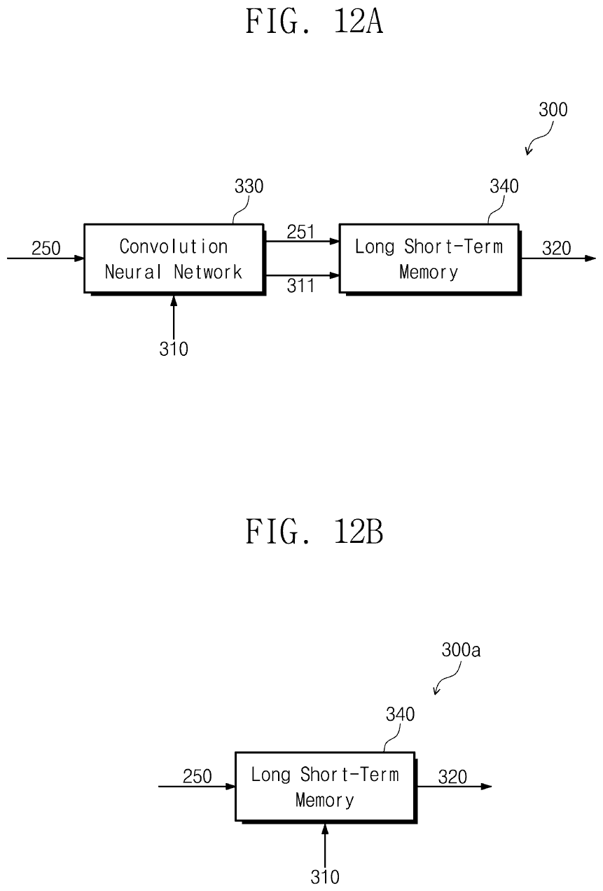

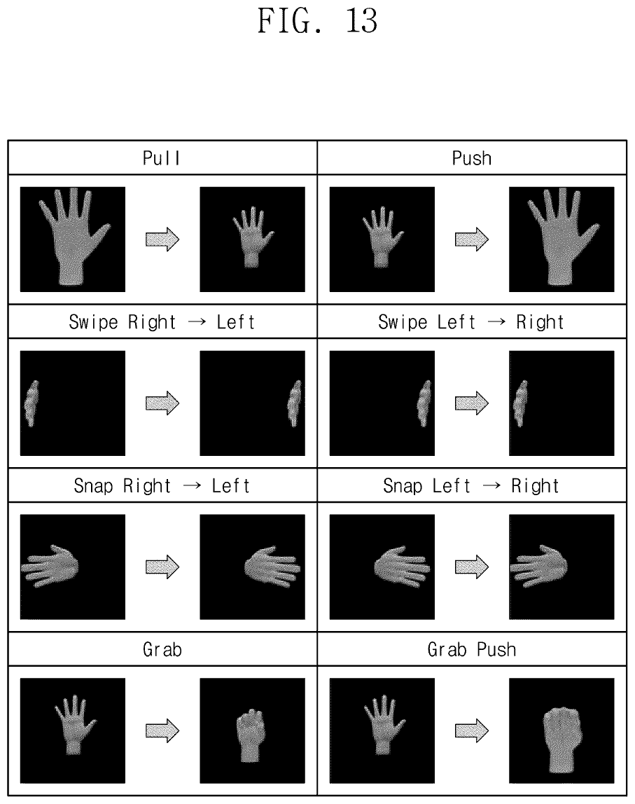

FIGS. 12A and 12B are block diagrams of a classification unit according to embodiments of the present disclosure.

Referring to FIG. 12A, the classification unit 300 may include a convolution neural network (CNN) 330 and a long short-term memory (LSTM) 340. The long short-term memory 340 may include recurrent neural networks (RNNs). The classification unit 300 may receive the correction input information 250 from the preprocessing unit 200 (refer to FIG. 1) and may output the predicted gesture 320 of the object 20 (refer to FIG. 1) based on the correction input information 250.

In the training process of the classification unit 300, the convolution neural network 330 may receive the training data 310 and may be trained using the training data 310. The convolution neural network 330 may generate intermediate training data 311 and may provide the intermediate training data 311 to the long short-term memory 340. The long short-term memory 340 may receive the intermediate training data 311 and may be trained using the intermediate training data 311.

In the classification process of the classification unit 300, the convolution neural network 330 may receive the correction input information 250 and may provide intermediate correction input information 251 obtained by converting the correction input information 250 to the long short-term memory 340. The long short-term memory 340 may output the predicted gesture 320 of the object 20 through the intermediate correction input information 251.

Referring to FIG. 12B, a classification unit 300a may include only the long short-term memory 340 without including the convolution neural network 330. In this case, the correction input information 250 and the training data 310 may be provided to the long short-term memory 340. In the training process of the classification unit 300a, the long short-term memory 340 is trained using the training data 310, and in the classification process of the classification unit 300a, the long short-term memory 340 may output the predicted gesture 320 of the object through the correction input information 250.

FIG. 13 is a diagram illustrating types of gestures, according to an embodiment of the present disclosure.

Referring to FIG. 13, the object 20 (refer to FIG. 1) may perform gestures such as a push (approaching the sensing unit 100 (refer to FIG. 1) while keeping the hand open), a pull (moving away from the sensing unit 100 while keeping the hand open), a swipe (moving the hand left and right over the sensing unit 100, a snap (moving the wrist left and right over the sensing unit 100, a grab (grabbing while keeping the hand open), and a grab push (grabbing while keeping the hand open and approaching the sensing unit 100).

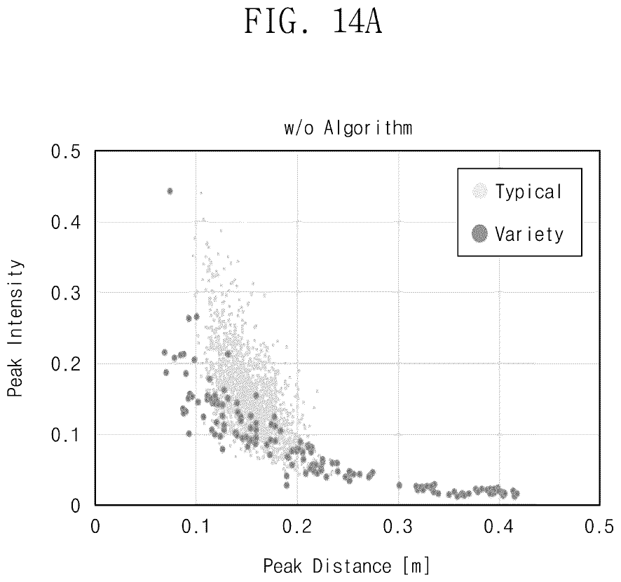

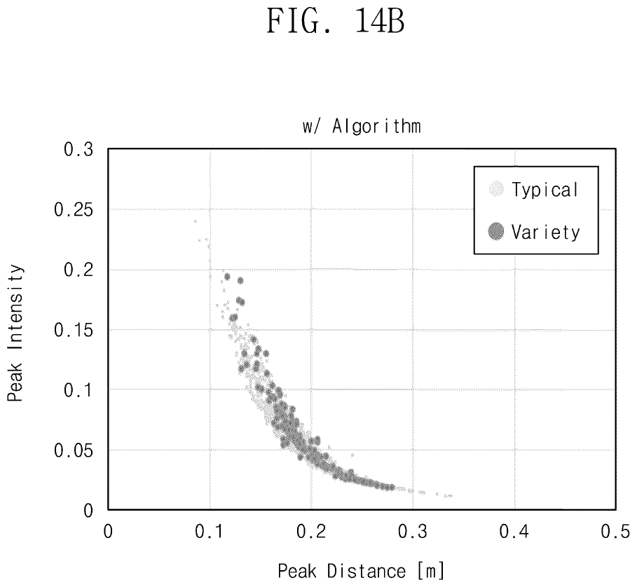

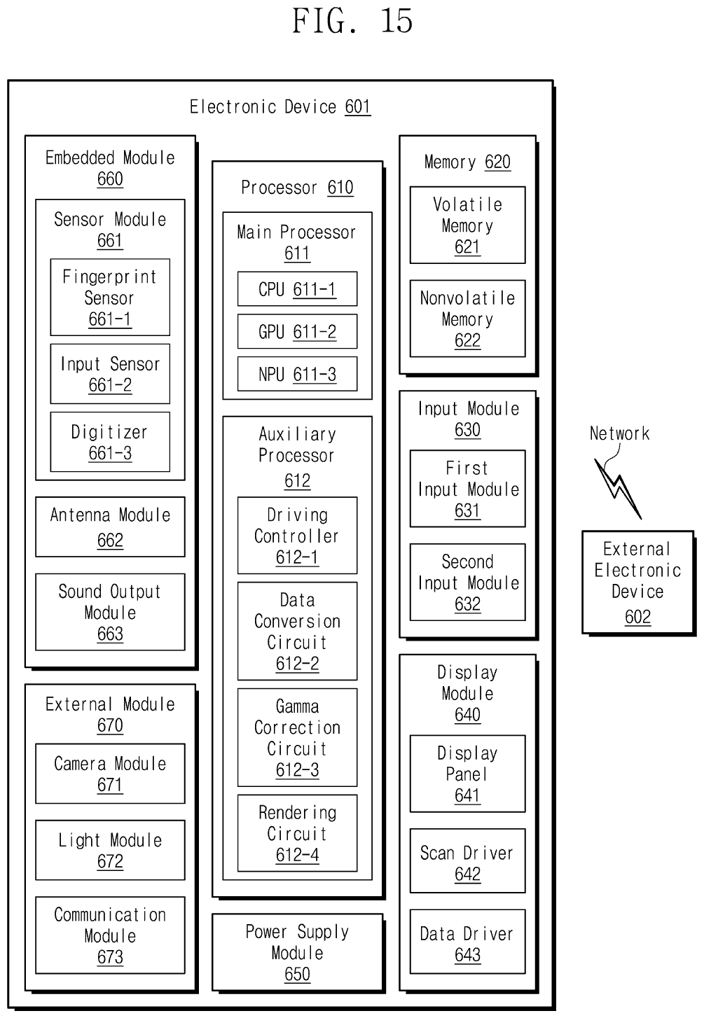

FIG. 14A is a graph illustrating a correlation between a peak distance and a peak intensity, according to a comparative example. FIG. 14B is a graph illustrating a correlation between a peak distance and a peak intensity, according to an embodiment of the present disclosure.

FIGS. 14A and 14B illustrate the results of not applying the algorithm of the present disclosure and the results of applying the algorithm of the present disclosure under a first condition (or a typical condition) and a second condition (or a variety condition), respectively. The first condition is when a gesture is performed at a distance of 30 cm from the sensing unit 100 (refer to FIG. 1), and the second condition is when a gesture is performed at a distance of 20 cm to 60 cm from the sensing unit 100.

When training is performed under the first condition and verification is performed under the second condition, the correlation between the range of the peak signal and the intensity of the peak signal under the first condition is not similar to the correlation between the range of the peak signal and the intensity of the peak signal under the second condition, so a recognition accuracy of the verification result may be low. The gesture sensing system 10 (refer to FIG. 1) according to an embodiment of the present disclosure may correct the range of the peak signal and the intensity of the peak signal within a uniform range through the preprocessing unit 200 (refer to FIG. 1), so that the correlation between the range of the peak signal and the intensity of the peak signal of the first condition may be similar to the correlation between the range of the peak signal and the intensity of the peak signal of the second condition. Therefore, even if training is performed using only the training data of the first condition without separate training data of the second condition, high recognition accuracy may be obtained even in the verification process for the second condition.

FIG. 36 is a block diagram of an electronic device, according to an embodiment of the present disclosure.

Referring to FIG. 36, an electronic device 601 outputs various pieces of information through a display module 640 within an operating system. When a processor 610 executes an application stored in a memory 620, a display module 640 provides application information to a user through a display panel 641.

The processor 610 obtains an external input through an input module 630 or a sensor module 661 and executes an application corresponding to the external input. For example, when the user selects a camera icon displayed on the display panel 641, the processor 610 obtains a user input through an input sensor 661-2 and activates a camera module 671. The processor 610 delivers image data corresponding to a captured image obtained through the camera module 671 to the display module 640. The display module 640 may display an image corresponding to the captured image through the display panel 641.

For another example, when personal information is authenticated on the display module 640, a fingerprint sensor 661-1 obtains entered fingerprint information as input data. The processor 610 compares input data obtained through the fingerprint sensor 661-1 with authentication data stored in the memory 620 and executes an application based on the comparison result. The display module 640 may display information, which is executed depending on the logic of the application, through the display panel 641.

For another example, when a music streaming icon displayed on the display module 640 is selected, the processor 610 obtains a user input through the input sensor 661-2 and activates the music streaming application stored in the memory 620. When a music play command is input by the music streaming application, the processor 610 provides sound information corresponding to the music play command to the user by activating a sound output module 663.

The operation of the electronic device 601 has been briefly described above. Hereinafter, a configuration of the electronic device 601 will be described in detail. Some of components of the electronic device 601, which will be described below, may be integrated and provided as one configuration, or the one configuration may be provided to be separated into two or more configurations.

Referring to FIG. 36, the electronic device 601 may communicate with an external electronic device 602 through a network (e.g., a short-range wireless communication network or a long-range wireless communication network). According to an embodiment, the electronic device 601 may include the processor 610, the memory 620, the input module 630, the display module 640, a power supply module 650, an embedded module 660, and an external module 670. According to an embodiment, in the electronic device 601, at least one of the above-described components may be omitted, or one or more other components may be added. According to an embodiment, some (e.g., the sensor module 661, an antenna module 662, or the sound output module 663) of the components described above may be integrated into another component (e.g., the display module 640).

The processor 610 may execute software to control at least another component (e.g., hardware or software component) of the electronic device 601 connected to the processor 610, and may process and calculate various types of data. According to an embodiment, as at least part of data processing or calculation, the processor 610 may store instructions or data received from other components (e.g., the input module 630, the sensor module 661 or a communication module 673) into a volatile memory 621, may process instructions or data stored in the volatile memory 621. The result data may be stored in a nonvolatile memory 622.

The processor 610 may include a main processor 611 and an auxiliary processor 612. The main processor 611 may include one or more of a central processing unit (CPU) 611-1 or an application processor (AP). The main processor 611 may further include one or more of a graphic processing unit (GPU) 611-2, a communication processor (CP), and an image signal processor (ISP). The main processor 611 may further include a neural processing unit (NPU) 611-3. The NPU 611-3 may be a processor that is specialized in processing an artificial intelligence model. The artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure. At least two of the processing units and the processors that are described above may be implemented as one integrated component (e.g., a single chip) or may be implemented as independent components (e.g., a plurality of chips).

The auxiliary processor 612 may include a driving controller 612-1. The driving controller 612-1 may include an interface converting circuit and a timing control circuit. The driving controller 612-1 receives an image signal from the main processor 611, converts the data format of the image signal so as to be suitable for the interface specifications with the display module 640, and outputs image data. The driving controller 612-1 may output various control signals to drive the display module 640.

The auxiliary processor 612 may further include a data converting circuit 612-2, a gamma correcting circuit 612-3, and a rendering circuit 612-4. The data converting circuit 612-2 may receive the image data from the driving controller 612-1 and may compensates for the image data such that an image is displayed at a desired luminance according to characteristics of the electronic device 601 or setting of the user or may convert the image data to reduce power consumption or compensate for afterimages. The gamma correcting circuit 612-3 may convert the image data, a gamma reference voltage, or the like such that the image displayed on the electronic device 601 has desired gamma characteristics. The rendering circuit 612-4 may receive the image data from the driving controller 612-1 and may render the image data in consideration of a pixel arrangement of the display panel 641 applied to the electronic device 601. At least one of the data converting circuit 612-2, the gamma correcting circuit 612-3, and the rendering circuit 612-4 may be integrated into another component (e.g., the main processor 611 or the driving controller 612-1). At least one of the data converting circuit 612-2, the gamma correcting circuit 612-3, and the rendering circuit 612-4 may be integrated into a data driver 643.

The memory 620 may store various pieces of data, which are used by at least one component (e.g., the processor 610 or the sensor module 661) of the electronic device 601 and input data or output data for commands related thereto. The memory 620 may include at least one or more of the volatile memory 621 and the nonvolatile memory 622.

The input module 630 may receive, from the outside (e.g., the user or an external electronic device 602) of the electronic device 601, commands or data to be used in a components (e.g., the processor 610, the sensor module 661, or the sound output module 663) of the electronic device 601.

The input module 630 may include a first input module 631, through which the commands or data are input from the user, and a second input module 632 through which the commands or data are input from the external electronic device 602. The first input module 631 may include a microphone, a mouse, a keyboard, a key (e.g., a button), or a pen (e.g., a passive pen or an active pen). The second input module 632 may support a designated protocol capable of being connected to the external electronic device 602 by wire or wirelessly. According to an embodiment, the second input module 632 may include a high definition multimedia interface (HDMI), a universal serial bus (USB) interface, a secure digital (SD) card interface, or an audio interface. The second input module 632 may include a connector that may be physically connected to the external electronic device 602, for example, an HDMI connector, a USB connector, an SD card connector, or an audio connector (e.g., a headphone connector).

The display module 640 provides visual information to the user. The display module 640 may include the display panel 641, a scan driver 642, and the data driver 643. The display module 640 may further include a window, a chassis, a bracket, or the like for protecting the display panel 641. The display module 640 may further include a light emitting driver, a voltage generator, and the like. The voltage generator may output various voltages (e.g., the first and second driving voltages ELVDD and ELVSS (see FIG. 1)) to drive the display panel 641.

The power supply module 650 supplies power to the components of the electronic device 601. The power supply module 650 may include a battery that charges a power voltage. The battery may include a non-rechargeable primary cell, a rechargeable secondary cell, a fuel cell, or the like. The power supply module 650 may include a power management integrated circuit (PMIC). The PMIC supplies optimized power to the above-described modules and modules which will be described below. The power supply module 650 may include a wireless power transmission/reception member electrically connected to the battery. The wireless power transmission/reception member may include a plurality of coil-shaped antenna radiators.

The electronic device 601 may further include the embedded module 660 and the external module 670. The embedded module 660 may include the sensor module 661, the antenna module 662, and the sound output module 663. The external module 670 may include the camera module 671, a light module 672, and the communication module 673.

The sensor module 661 may detect an input from the user's body or an input from a pen among the first input module 631, and may generate an electrical signal or data value corresponding to the input. The sensor module 661 may include at least one of the fingerprint sensor 661-1, the input sensor 661-2, and a digitizer 661-3.

The fingerprint sensor 661-1 may generate a data value corresponding to a fingerprint of the user. The fingerprint sensor 661-1 may include one of an optical-type fingerprint sensor, or a capacitance-type fingerprint sensor.

The input sensor 661-2 may generate a data value corresponding to coordinate information of an input by a body of the user or an input by a pen. The input sensor 661-2 generates the change in capacitance due to the input as the data value. The input sensor 661-2 may sense an input by a passive pen or may transmit or receive data to or from an active pen.

The input sensor 661-2 may also measure a biometric signal such as blood pressure, moisture, or body fat. For example, when the user touches a part of the body to a sensor layer or sensing panel and does not move during a specific period, the input sensor 661-2 may detect the biometric signal and may output information desired by the user to the display module 640 based on a changes in electric fields caused by the part of the body.

The digitizer 661-3 may generate the data value corresponding to coordinate information of an input by the pen. The digitizer 661-3 generates an electromagnetic change amount due to the input as the data value. The digitizer 661-3 may sense input by the passive pen or transmit or receive data to or from the active pen.

At least one of the fingerprint sensor 661-1, the input sensor 661-2, and the digitizer 661-3 may be implemented as a sensor layer formed on the display panel 641 through a subsequent process. The fingerprint sensor 661-1, the input sensor 661-2, and the digitizer 661-3 may be placed on the upper side of the display panel 641, and one (e.g., the digitizer 661-3) of the fingerprint sensor 661-1, the input sensor 661-2, and the digitizer 661-3 may be placed on the lower side of the display panel 641.

At least two or more of the fingerprint sensor 661-1, the input sensor 661-2, and the digitizer 661-3 may be formed to be integrated into one sensing panel through the same process. When being integrated into one sensing panel, the sensing panel may be placed between the display panel 641 and a window placed on the upper side of the display panel 641. According to an embodiment, the sensing panel may be placed on a window, and the location of the sensing panel is not particularly limited thereto.

At least one of the fingerprint sensor 661-1, the input sensor 661-2, and the digitizer 661-3 may be built into the display panel 641. That is, at least one of the fingerprint sensor 661-1, the input sensor 661-2, and the digitizer 661-3 may be simultaneously formed through a process of forming elements (e.g., a light emitting element, a transistor, or the like) included in the display panel 641.

Besides, the sensor module 661 may generate an electrical signal or a data value corresponding to the internal state or external state of the electronic device 601. For example, the sensor module 661 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The antenna module 662 may include one or more antennas to transmit or receive the signal or power to or from an external source. According to an embodiment, the communication module 673 may transmit or receive the signal to or from the external electronic device through the antenna suitable for a communication method. An antenna pattern of the antenna module 662 may be integrated into the input sensor 661-2 or one component (e.g., the display panel 641) of the display module 640.

The sound output module 663 may be a device for outputting an audio signal to the outside of the electronic device 601 and, for example, may include a speaker used for general purposes, such as multimedia playback or recording playback, and a receiver used only for receiving a call. According to an embodiment, the receiver may be implemented separately from the speaker or may be integrated with the speaker. A sound output pattern of the sound output module 663 may be integrated into the display module 640.

The camera module 671 may shoot a still image or a video image. According to an embodiment, the camera module 671 may include one or more lenses, an image sensor, or an image signal processor. The camera module 671 may further include an infrared camera capable of measuring the presence or absence of the user, a position of the user, a gaze of the user, or the like.

The light module 672 may provide light. The light module 672 may include a light emitting diode or a xenon lamp. The light module 672 may operate in conjunction with the camera module 671 or may operate independently from the camera module 671.

The communication module 673 may support establishing a wired or wireless communication channel between the electronic device 601 and the external electronic device 602 and performing communication through the established communication channel. The communication module 673 may include one or all of wireless communication modules such as a cellular communication module, a short-range wireless communication module, or a global navigation satellite system (GNSS) communication module, or wired communication modules such as a local area network (LAN) communication module or a power line communication module. The communication module 673 may communicate with the external electronic device 602 through a short-range communication network such as Bluetooth, WiFi direct, or infrared data association (IrDA) or a long-range communication network such as a cellular network, Internet, or a computer network (e.g., the LAN or a wide area network (WAN)). The above-mentioned various communication modules 673 may be implemented into one chip or may be implemented into separate chips, respectively.

The input module 630, the sensor module 661, the camera module 671, and the like may be utilized to control an operation of the display panel 641 in conjunction with the processor 610.

The processor 610 outputs commands or data to the display module 640, the sound output module 663, the camera module 671, or the light module 672 based on input data received from the input module 630. For example, the processor 610 may generate image data in response to input data applied through a mouse, an active pen, or the like to output the generated image data to the display module 640 or may generate command data in response to the input data to output the generated command data to the camera module 671 or the light module 672. When no input data is received from the input module 630 during a specific period, the processor 610 may switch an operation mode of the electronic device 601 to a low-power mode or a sleep mode to reduce power consumed in the electronic device 601.

The processor 610 outputs commands or data to the display module 640, the sound output module 663, the camera module 671, or the light module 672 based on sensing data received from the sensor module 661. For example, the processor 610 may compare authentication data authorized by the fingerprint sensor 661-1 with the authentication data stored in the memory 620, and then may execute an application depending on the comparison result. The processor 610 may execute commands or may output corresponding image data to the display module 640 based on sensing data sensed by the input sensor 661-2 or the digitizer 661-3. When the sensor module 661 includes a temperature sensor, the processor 610 receives temperature data regarding the measured temperature from the sensor module 661 and may further perform luminance correction on image data based on the temperature data.

The processor 610 may receive measurement data regarding the presence or absence of the user, the user's location, and the user's gaze from the camera module 671. The processor 610 may further perform luminance correction on the image data based on the measurement data. For example, the processor 610 that determines the presence or absence of the user through an input from the camera module 671 may output image data, of which the luminance is corrected, to the display module 640 through the data converting circuit 612-2 or the gamma correcting circuit 612-3.

Some of the components may be connected to each other through communication methods between peripheral devices, for example, a bus, a general purpose input/output (GPIO), a serial peripheral interface (SPI), a mobile industry processor interface (MIPI), or an ultra-path interconnect (UPI) link and may exchange a signal (e.g., commands or data) between each other. The processor 610 may communicate with the display module 640 through a mutually promised interface, and for example, may use any one of the above-described communication methods, and the present disclosure is not limited to the above-described communication methods.

The electronic device 601 according to various embodiments disclosed in the specification may be implemented with various types of devices. The electronic device 601 may include, for example, at least one of a portable communication device (e.g., a smart phone), a computer device, a portable multimedia device, a portable medical device, a camera, a wearable device, or a home appliance. The electronic device 601 according to an embodiment of this specification may not be limited to the above-described devices.

According to an embodiment of the present disclosure, the gesture sensing system may improve the efficiency of gesture classification by including a preprocessing unit that may correct various pieces of information included in input information within a specific range. Even if input information with high variability is input under various environmental conditions, the recognition accuracy of gestures may be effectively improved by performing a uniformization operation through the preprocessing unit. In addition, the number of data sets required for the gesture sensing system to train may be reduced, and as a result, the miniaturization of the gesture sensing system may be realized.

Although the present disclosure has been described above with reference to embodiments thereof, it will be understood by those skilled in the art or having ordinary knowledge in the art that various modifications, and substitutions are possible, without departing from the spirit and the technical scope of the present disclosure as set forth in the claims below. Accordingly, the technical scope of the present disclosure is not limited to the detailed description of this specification, but should be defined by the claims.

What is claimed is:

1. A gesture sensing system comprising:
a sensing unit configured to sense a gesture of an object and to generate and output input information including a plurality of sensing signals;
a preprocessing unit configured to detect a peak signal among the plurality of sensing signals and to convert the input information into correction input information using information associated with the peak signal; and
a classification unit configured to be trained using training data and to classify the gesture based on the correction input information, and
wherein the information associated with the peak signal includes information related to a position of the peak signal and an intensity of the peak signal, and
wherein the position of the peak signal and the intensity of the peak signal are uniformized to a uniform range and then provided to the classification unit.

2. The gesture sensing system of claim 1, wherein the preprocessing unit includes:
a motion detection unit configured to sense whether the gesture is sensed;
a signal detection unit configured to detect the peak signal among the plurality of sensing signals;
a position correction unit configured to correct the position of the peak signal and to output a correction position of the peak signal; and
an intensity correction unit configured to correct the intensity of the peak signal and to output a correction intensity of the peak signal.

3. The gesture sensing system of claim 2, wherein the input information further includes:
a range signal including information associated with a distance between the sensing unit and the object; and
a Doppler signal including information associated with a speed of the object, and
wherein a position of each of the plurality of sensing signals is a position on a range-Doppler map expressed by the range signal and the Doppler signal,
wherein the sensing unit generates the input information for each frame, and
wherein the correction input information includes information associated with the correction position of the peak signal and the correction intensity of the peak signal with respect to given frames.

4. The gesture sensing system of claim 3, wherein the motion detection unit is configured to:
calculate a differential signal intensity by using a difference in signal intensity with respect to the range-Doppler map of each frame and a previous frame of the each frame among the given frames;
calculate an average value of the differential signal intensities of the given frames; and
determine whether the gesture is sensed using the average value.

5. The gesture sensing system of claim 3, wherein the motion detection unit is configured to:
calculate a differential signal intensity by using a difference in signal intensity with respect to the range-Doppler map of two adjacent frames;
calculate a normalized signal intensity by normalizing the differential signal intensity; and
determine whether the gesture is sensed using the normalized signal intensity.

6. The gesture sensing system of claim 3, wherein the signal detection unit is configured to:
select sensing signals having an intensity greater than a threshold value among the plurality of sensing signals.

7. The gesture sensing system of claim 6, wherein the signal detection unit is configured to:
select a first signal, a second signal, a third signal, and a fourth signal from among selected sensing signals for each frame, and
wherein the first signal is a sensing signal having a greatest intensity among the selected sensing signals,
wherein the second signal is a sensing signal having a smallest difference from center position of the selected sensing signals, among the selected sensing signals,
wherein the third signal is a sensing signal having a smallest difference in position between a previous frame and a current frame among the selected sensing signals, and
wherein the fourth signal is a sensing signal located at a position where a Doppler is minimum or maximum among the selected sensing signals.

8. The gesture sensing system of claim 7, wherein the signal detection unit is configured to:
detect a sensing signal at a position where the range is a smallest among the first to fourth sensing signals as the peak signal.

9. The gesture sensing system of claim 3, wherein the position correction unit is configured to:
determine whether a current frame is a first frame, and
wherein the first frame is a frame at which the motion detection unit determines that the gesture is initiated.

10. The gesture sensing system of claim 9, wherein the position correction unit is configured to:
calculate the position of the detected peak signal as an initiation position when the current frame is the first frame, and
calculate a difference between the position of the current frame and a position of a previous frame when the current frame is not the first frame.

11. The gesture sensing system of claim 10, wherein the position correction unit is configured:
not to correct the position of the current frame when the difference is within a reference distance, and
to correct the position of the peak signal of the current frame when the difference exceeds the reference distance.

12. The gesture sensing system of claim 3, wherein the intensity correction unit is configured to:
correct the intensity of the peak signal using the training data, and
wherein the training data includes information on a correlation between the range of the peak signal and the intensity of the peak signal.

13. The gesture sensing system of claim 12, wherein the training data includes information on recognizable gestures for a training target as one.

14. The gesture sensing system of claim 12, wherein the training data includes information on each gesture, of recognizable gestures, for a training target as an individual.

15. The gesture sensing system of claim 14, wherein the intensity correction unit is configured to:
compare the intensity of the peak signal for each gesture with the intensity of the peak signal during given frames,
select the gesture for which the intensity of the peak signal is closest to the intensity of the peak signal during the given frames among the gestures, and
correct the intensity of the peak signal based on the selected gesture.

16. The gesture sensing system of claim 1, wherein the sensing unit is configured to:
generate an intermediate signal using a transmission signal and a reception signal;
convert the intermediate signal into intermediate signal data through an analog-to-digital conversion; and
apply a Fourier transform to the intermediate signal data so as to be converted into the input information.

17. The gesture sensing system of claim 16, wherein the sensing unit is configured to:
apply the Fourier transform to the intermediate signal data to calculate a range signal; and
apply the Fourier transform to the range signal to calculate a Doppler signal.

18. The gesture sensing system of claim 17, wherein the transmission signal and the reception signal are millimeter waves.

19. The gesture sensing system of claim 1, wherein the classification unit includes a convolution neural network and a long short-term memory,
wherein, in a training process of the classification unit, the convolution neural network receives the training data to be trained, and
wherein, in a classification process of the classification unit, the long short-term memory outputs a predicted gesture.

20. An electronic device comprising:
a sensing unit configured to sense a gesture of an object and to generate and output input information including a plurality of sensing signals;
a preprocessing unit configured to detect a peak signal among the plurality of sensing signals and to convert the input information into correction input information using information associated with the peak signal; and
a classification unit configured to be trained using training data and to classify the gesture based on the correction input information, and
wherein the information associated with the peak signal includes information related to a position of the peak signal and an intensity of the peak signal, and
wherein the position of the peak signal and the intensity of the peak signal are uniformized to a uniform range and then provided to the classification unit.
